(19) United States
(12) Patent Application Publication
(10) Pub. No.: US 2003/0164653 A1
(43) Pub. Date: Sep. 4, 2003

(54) Fluid dynamic pressure bearing for small flat motor, small flat motor, fan motor, and forced air feed type air cell

(76) Inventor: Hisafumi Yasuda, Adachi-ku (JP)

Correspondence Address: NIXON PEABODY, LLP, 8180 GREENSBORO DRIVE, SUITE 800, MCLEAN, VA, 22102, US

(21) Appl. No.: 10/240,088

(22) PCT Filed: Jan. 28, 2002
(86) PCT No.: PCT/JP02/00618

(30) Foreign Application Priority Data
Jan. 30, 2001 (JP) 2001-021970

(51) Int. Cl. H02K 7/08; H02K 5/16

(52) U.S. Cl. 310/90

(57) ABSTRACT

This invention has a stator 10 having a coil 10a wound on a core 10b, a rotor 11 having a yoke 11b that holds a magnet 11a facing the core 10a, in which an impeller 12 is attached to the rotor 10 that is supported by a hydraulic bearing 13 having a fluid sump 13f that communicates with the thrust receiver 13a of a bearing housing 13b and a fluid receiver groove 13c, and that is formed around the outer periphery of a hydraulic sleeve 13d fitted within the inner cylinder of the bearing housing 13b.

Hydraulic bearing for a small, flat motor; small, flat motor; fan motor; and forced-air air cell.

### SCOPE OF PATENT CLAIMS

This invention concerns improvement of a hydraulic bearing for a small, flat motor; small, flat motor; fan motor; and forced-air air cell.

### FIELD OF TECHNOLOGY

This invention concerns improvement of hydraulic bearings for small, flat motors; small, flat motors; fan motors; and forced-air air cells.

### PRIOR ART

Taking fan motors as one example of small, flat motors, a proposal has been made previously to make a fan motor with a stator that has a coil wound around a core, a rotor in which a magnet facing the core is held by a yoke, an impeller attached to the rotor, and a bearing seat with ball bearings that supports the rotor shaft of the rotor, in which the interaction of magnetic force of the magnet and the electromagnetic force of the coil produce the rotational force of the rotor (JPO Kokai patent report H6-141507).

In this fan motor, the bearing for the rotor is assembled with ball bearings, and so the rotor shaft of the rotor must be of some length, which imposes limits on efforts to reduce the overall height of the motor. Further, because the ball bearings tend to produce noise and vibration, the motor is not well suited to assembly in a mobile telephone, an electronic notebook or other portable information equipment.

A small, flat motor has been proposed in which the ball bearings are replaced with a bearing sleeve of lubricated metal, with the sleeve fitted and fixed in a bearing housing, such that the bearing sleeve supports the rotor shaft of the rotor (JPO Kokai patent report 2000-166173). This small, flat motor produces less noise than that with ball bearings, but the noise cannot be reduced to the near-zero level. This bearing also has the disadvantage of a shorter service life than ball bearings or dynamic pressure bearings.

There is also a fan motor that is used in air batteries of the forced-air feed type that is intended to prevent noise and vibration. As illustrated in FIG. 13, it has a stator with a coil wound around a core (winding not illustrated), a rotor 2 that has a magnet 2a that faces the coil held in a yoke 2b, with an impeller 3 attached to the rotor 2. There is a circuit board 4 below the stator 1, and the bearing mechanism 5 that supports the rotor shaft 2c of the rotor 2 is held by a spiral spring 6 that suspends the entire motor above the mounting substrate 7.

This spiral spring mounting mechanism not only lacks stability in terms of stopping vibration of the motor as a whole in the event of impact, but it is also undesirable from the perspective of making the fan motor smaller and thinner as an assembled piece of equipment. Especially in the case of an air cell of the forced-air feed type with a fan motor to be assembled in portable information equipment, it is necessary to be smaller, thinner, lighter and less noisy, with a longer service life.

This invention focuses on a hydraulic bearing to suppress the generation of noise; its purpose is to provide a hydraulic bearing for small, flat motors that reduces the generation of noise and also extends service life, by devising a simple means to facilitate circulation of the fluid.

Next, this invention has the purpose of providing a small, flat motor that is smaller and thinner because of the stator design.

This invention has the additional purpose of providing a small, flat motor that is smaller and thinner because of the means of mounting the electronic parts.

Further, this invention has the purpose of providing a fan motor in which noise and vibration are prevented by the design of the rotor bearing.

Along with prevention of noise and vibration, this invention has the purpose of providing an air cell of the forced-air feed type with lighter overall weight and longer service life because the fan motor and the air cell are smaller.

The purposes stated above are the primary technical issues; other purposes will become clear in the explanation below of the optimum mode of implementation of the invention.

### PRESENTATION OF INVENTION

In order to achieve the purposes stated above, the hydraulic bearing for a small, flat motor of this invention has a cylindrical bearing housing with a thrust receiver inside at the bottom, and a dynamic pressure sleeve that has a bearing hole that supports the rotor shaft of the motor and that is fitted and fixed within the bearing housing; a fluid receiver groove in the inner surface of the bearing hole accommodates fluid that flows around the rotor shaft from the thrust receiver of the bearing housing, and a number of partition walls that contact the inner surface of the bearing hole, separating cutout spaces that extend downward from the top surface that covers the openings between adjoining partition walls, form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces.

Further, in the small, flat motor of this invention there is a stator with a coil wound on a core, and a rotor with a magnet that faces the core held by a yoke, the core having an insulating coating applied by resin-molding that covers both sides of the reel for winding the coil, and the stator being assembled with the coil wound on the reel of the core with the insulating material intervening between the coil and core.

Further, in the small, flat motor of this invention, an oxide coating is applied to the top and bottom surfaces of the core, which is formed from a silicon steel sheet.

Further, in the small, flat motor of this invention, terminal pins are held at the outer framework of the insulating resin that has been applied to the core, and a thin sheet of flexible print cord beneath the stator serves as a circuit board; one end of each terminal pin, to which the terminal of the coil is wired, is soldered and fixed to the flexible print cord.

Further, in the small, flat motor of this invention, there is a mounting substrate that has openings corresponding to the locations of the terminal pins; the openings in the mounting substrate accommodate terminal pin solder terminals that project to the back surface of the flexible print cord. The openings can be packed with adhesive resin to resin-mold the solder terminals.

Further, in the small, flat motor of this invention, there are a stator having a coil wound on a core, a rotor having a yoke that holds a magnet facing the core, a circuit board that makes a continuous circuit with the coil of the rotor and that has certain electronic components mounted on its back. There are openings in the mounting substrate corresponding to the positions where the electronic components are mounted, and these openings accommodate the electronic components mounted on the back of the circuit board. An adhesive resin is packed into the openings of the mounting substrate for resin molding of the electronic components.

Further, in the fan motor of this invention, there is a stator having a coil wound on a core, a rotor having a yoke that holds a magnet facing the core, and an impeller. There is a cylindrical bearing housing with a thrust receiver inside at the bottom, and a dynamic pressure sleeve that has a bearing hole that supports the rotor shaft of the motor and that is fitted and fixed within the bearing housing; a fluid receiver groove in the inner surface of the bearing hole accommodates fluid that flows around the rotor shaft from the thrust receiver of the bearing housing, and a number of partition walls that contact the inner surface of the bearing hole, separating cutout spaces that extend downward from the top surface that covers the openings between adjoining partition walls, form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces.

Further, in the fan motor of this invention, there is a hydraulic bearing assembled from a bearing housing, which rises from the surface of the mounting substrate and is formed as a single piece with the mounting substrate, and a hydraulic sleeve that is fitted and fixed within the cylinder of the bearing housing.

Further, in the fan motor of this invention, there is a bearing housing formed in one piece with the mounting substrate of aluminum or a resin.

Further, in the forced-air feed type air cell of this invention, there is a fan motor as described in any of claims 7 through 9 of this application.

### BRIEF EXPLANATION OF THE DRAWINGS

FIG. 1 is a side section that shows a fan motor in one mode of implementation of this invention.

FIG. 2 is a plane view of the core used in the stator of that motor.

FIG. 3 is a side section of the core in FIG. 2.

FIG. 4 is a side section that shows primarily the hydraulic bearing of the fan motor in FIG. 1.

FIG. 5 is a bottom view of the dynamic pressure sleeve used in that hydraulic bearing.

FIG. 6 is a side view of the dynamic pressure sleeve in FIG. 5.

FIG. 7 is a plane view of the dynamic pressure sleeve in FIG. 5.

FIG. 8 is a side section of the dynamic pressure sleeve in FIG. 5.

FIG. 9 is a partial side section, from a different angle, of the fan motor in FIG. 1.

FIG. 10 is an oblique view of the fan motor in FIG. 1, with the rotor assembled.

FIG. 11 is an oblique view of the fan motor in FIG. 1 in completed form.

FIG. 12 is an explanatory drawing of the fan motor used in the forced-air feed air cell of this invention.

FIG. 13 is an explanatory drawing of the fan motor used in a conventional forced-air feed air cell.

### OPTIMUM MODE OF IMPLEMENTATION OF THE INVENTION

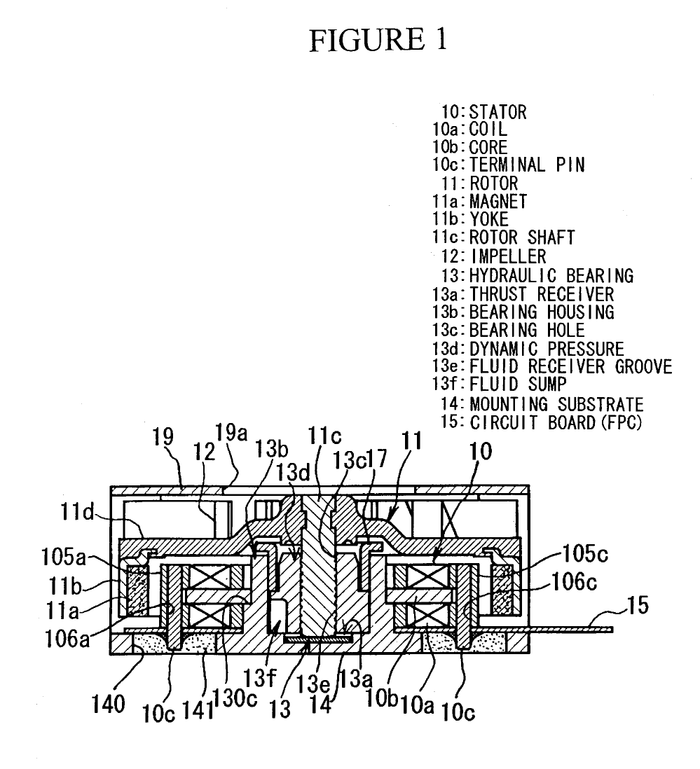

The explanation given below makes reference to the attached drawings. FIG. 1 shows a fan motor with a small, flat construction, as the optimum mode of implementation of this invention. This fan motor has a stator 10 with a coil 10a wound on a cores 10a . . . , and a rotor 11 on which a magnet 11a that faces the cores 10a . . . is held by a yoke 11b. An impeller 12 with an array of numerous fins is attached to the rotor 11, and the rotor 11 is supported, free to rotate, in a hydraulic bearing 13.

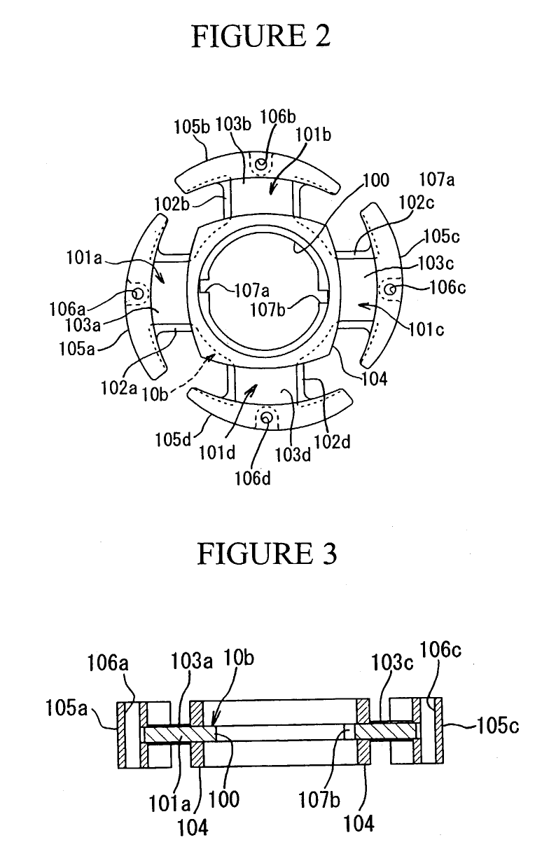

The stator 10 is assembled with a wing-shaped reel that is primarily the core 10b, as shown in FIGS. 2 and 3. This reel is made up primarily of the core 10b with a central ring 100 and multiple projections 101a to 101d that extend outward, separated by a fixed angle, from the periphery of the ring 100. the core 10b comprises a stack of multiple pieces punched from a sheet of silicon steel.

Within this core 10b, the projections 101a to 101d become the coil reel portion, and both sides of each of the projections 101a to 101d is coated with a coating 102a to 102d of an insulating resin (only one of the two sides of each projection is labeled with a key number) that is applied with a resin mold. The insulating coatings 102a to 102d can be thin in consideration of resin flow; the minimum thickness required is about 0.15 mm. The insulating coating can cover the entire top and bottom surfaces of the projections 101a to 101d, or protrude 2.5/100 mm from the top and bottom surfaces.

A thin oxide coating 103a to 103d can be applied to the top and bottom surfaces (only one of the two surfaces of each projection is labeled with a key number) of the projections 101a to 101d, as an insulating coating, by brushing, dipping, heat treatment, phosphate treatment, blackening treatment or other means.

In the core 10b, there is an inner frame 104 that rises from the central ring 100, and outer frames 105a to 105d that rise from the outer edges of the projections 101a to 101d, molded as a unit of resin. The inner frame 104 and outer frames 105a to 105d can be molded at the same time and of the same resin as the insulating coating 102a to 102d.

In the outer frames 105a to 105d of the core 10b, insertion holes 106a to 106d for terminal pins that connect to the coil terminals, as described hereafter, are molded in positions at the centers of U-shaped cutouts at the edges of the projections 101a to 101d. Further, there are in the central ring 100 of the core 10b notches 107a, 107b that engage the stop tabs (not illustrated) that project from the bearing housing of the hydraulic bearing to be described hereafter.

In the reel that consists primarily of the core 10b, the coil 10a . . . is wound on the projections 101a to 101d which are coated with oxide coverings 103a to 103d, with the insulating coatings 102a to 102d intervening between the coil 10a . . . and the core 10b. In this way, peeling or other damage to the insulating coating of the coil 10a . . . is prevented, and the core 10b is securely insulated. By winding the desired number of coils 10a . . . , the winding thickness of the coil 10a . . . can be kept thin so that a thin stator 10 can be assembled.

The coil 10a . . . can be wound in an orderly manner on the projections 101a to 101d, restrained by the inner frame 104 and the outer frames 105a to 105d. The terminal pins 10c . . . of four terminals shown in FIG. 1 (only two are illustrated) are inserted in the insertion holes 106a, 106c and held erect by outer frames 105a, 105c, and the terminals of the coils 10a . . . can be connected to the terminal pins 10c . . . for an easy and sure connection.

The rotor 11 has a ring-shaped magnet 11a on its inner periphery fixed to a yoke 11b on the outer periphery, and a rotor shaft 11c that is molded of resin in a single piece with a hub 11d, forming an outer rotor in a cup-like shape that can accommodate the stator 10. The rotor 11 has an impeller 12 with fins 12a, 12b . . . molded of resin as a single piece with the hub 11d, with the ribs rising from the top of the hub 11d.

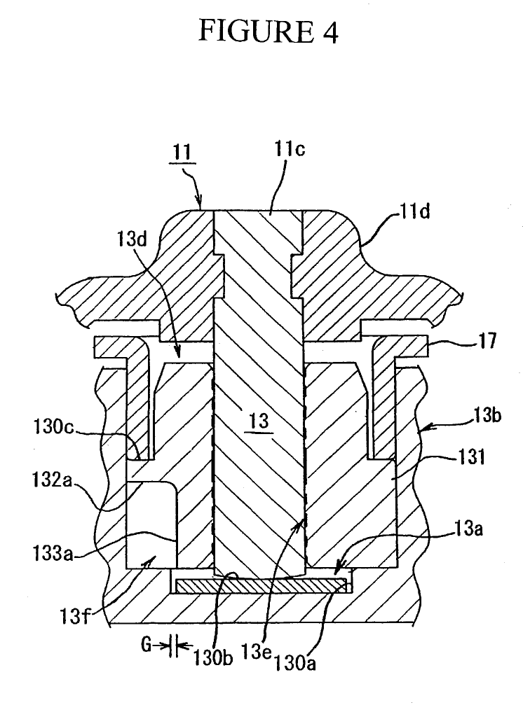

The hydraulic bearing 13 of the rotor 11, as shown in FIGS. 1 and 4, is assembled from a cylindrical bearing housing 13b with a thrust receiver 13a inside at the bottom, a bearing hole 13c that supports the rotor shaft 11c of the rotor 11, and a dynamic pressure sleeve 13d that is fitted and fixed inside the cylinder of the bearing housing 13b. Within the hydraulic bearing 13, on the inner surface of the bearing hole 13c is a fluid receiver groove 13e that accommodates the lubricating fluid that flows around the rotor shaft 11c from the thrust receiver 13a of the bearing housing 13b.

In this construction, the thrust receiver 13a consists of a concavity 130a at the bottom of the bearing housing 13b within which is set a thrust plate 130b that has a small peripheral surface. This thrust receiver 13a accommodates fluid within the concavity 130a, and is formed such that the thrust plate 130b within the concavity 130a stops the arc-shaped end of the rotor shaft 11c of the rotor 11.

The bearing housing 13b is formed in a single piece with a mounting substrate 14 and rises from the plate of the mounting substrate 14 to form the assembly base for the motor as a whole, as described hereafter. The bearing housing 13b can be molded in a single piece with the mounting substrate 14 of a light weight material such as aluminum or a shock-resistant resin. On the bearing housing 13b, there is a step 130c (see FIG. 1) with an outer periphery such that the stator 10 can be fitted and fixed to it by means of the ring 100 of the core 10b.

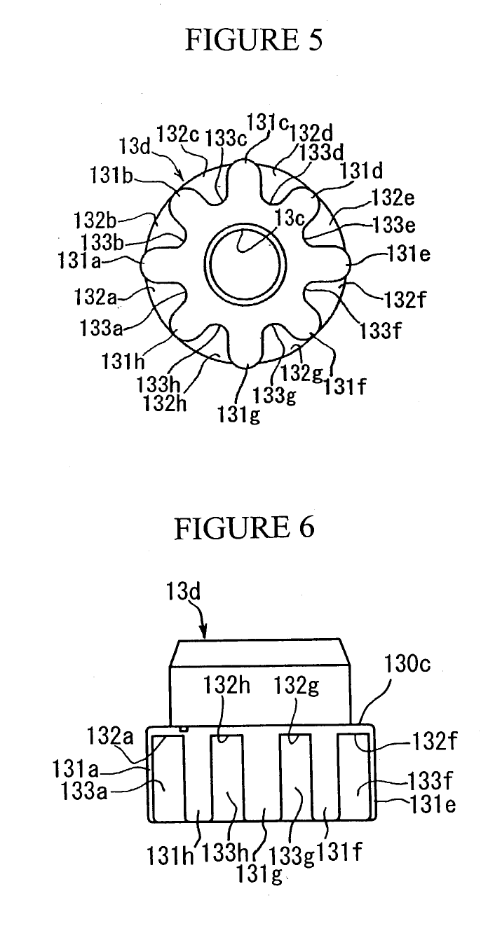

The dynamic pressure sleeve 13d has, as shown in FIGS. 1, 5 and 6, multiple partition walls 131a to 131h that contact the inner cylinder of the bearing housing 13b, separating cutout spaces 133a to 133h that extend downward from the top surface 132a to 132h that covers the openings between adjoining partition walls 131a to 131h. Fitting the dynamic pressure sleeve 13d into the bearing housing 13b thus forms the fluid sump 13f that accommodates the lubricating fluid.

The fluid sump 13f accommodates lubricating fluid around the periphery of the dynamic pressure sleeve 13d so as to reduce oil loss due to the heat produced by operation of the motor. By maintaining a gap G (see FIG. 4) between the lower inward portion of the cutouts 133a to 133h and the thrust receiver 13a of the bearing housing 13b when the dynamic pressure sleeve 13d is fitted into the cylinder of the bearing housing 13b, it is possible to circulate the lubricating fluid from the thrust receiver 13a of the bearing housing 13b into the fluid receiver groove 13e of the bearing hole 13c.

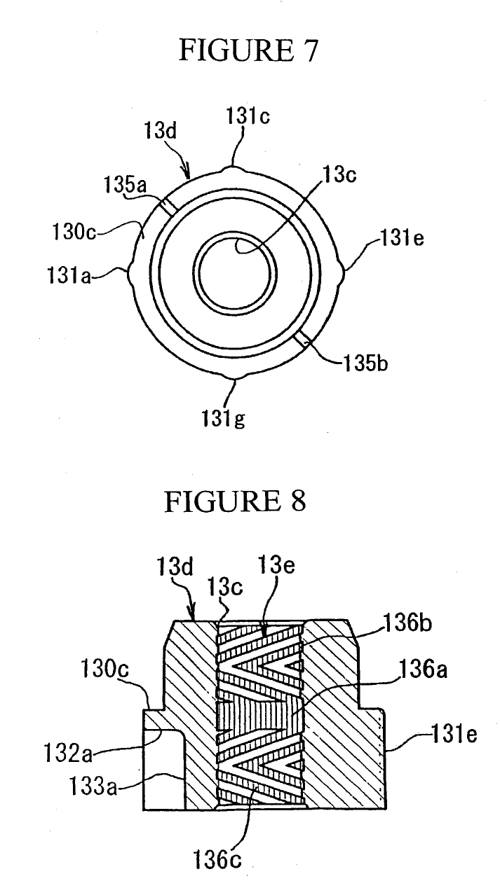

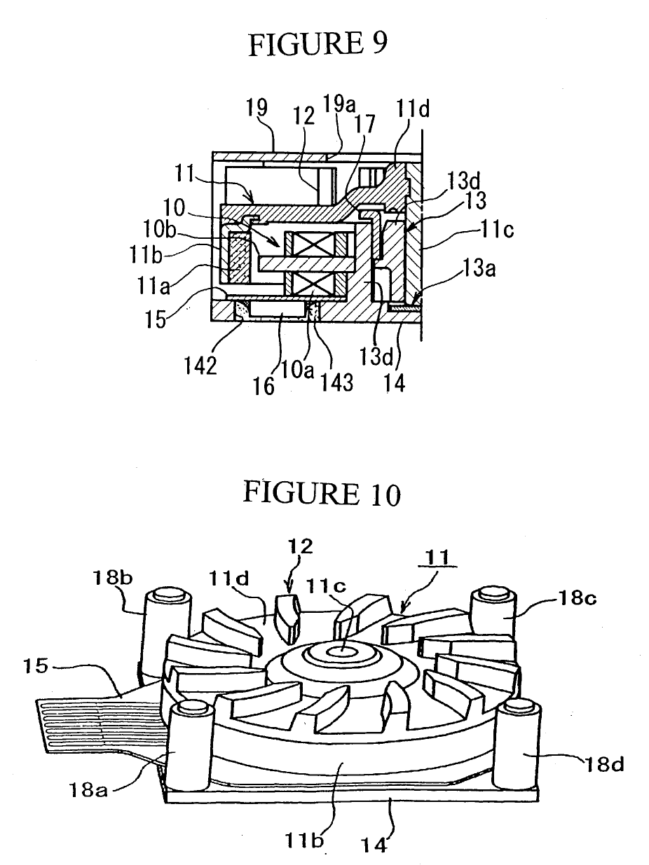

To facilitate the fitting of the dynamic pressure sleeve 13d and to maintain air tightness with the inner cylinder of the bearing housing 13b, the partition walls 131a to 131h have a semicircular shape where they contact the surface of the inner cylinder of the bearing housing 13b, and the partition walls 131a to 131h are positioned so that the arc-shaped surfaces extend slightly from the surface where they fit. Further, the upper side of the top surface 132a to 132h is formed with a step 130c that fits into a collar to be described hereafter. This step 134 has grooves 135a, 135b, as shown in FIG. 7, that match tabs on the collar.

The fluid receiver groove 13e that accommodates the fluid, as shown in FIG. 8, has a broad central groove 136a connected to above V-shaped groove 136b and below V-shaped groove 136c to allow circulation of the lubricating fluid. Because the hydraulic bearing 13 has this fluid receiver groove 13e, the fan motor has a long service life with a stable rate of rotation and low noise.

In addition to these constituent parts, there is a circuit board 15 on which are mounted the electronic parts that are necessary to the fan motor circuit. This circuit board 15 is a thin, flexible print cord that incorporates a wiring pattern, as shown in FIG. 1.

The flexible print cord 15 has a thin shape so that the the terminal pins 10c . . . that connect to the coils 10a . . . of the stator 10 can be held erect by the outer frame 105a, 105c, as shown in FIG. 1; by inserting the ends of the terminal pins 10c . . . through the cord surface and soldering the tips on the back surface, the circuit can be connected easily and securely. Moreover, electronic components such as Hall elements that detect rotation locations can be mounted on the back surface of the flexible print cord 15.

With the constituent parts described above, the fan motor can be built using the mounting substrate 14 as the assembly base and attaching the stator 10 and the rotor 11, which is supported by the hydraulic bearing 13.

During assembly, Hall elements and other electronic components are mounted on the flexible print cord 15, and the terminal pins 10c . . . to which the coils 10a . . . of the stator 10 are connected are inserted through the cord surface and the tips soldered on the back side, so that the stator 10 is mounted on the flexible print cord 15 in advance.

The stator 10 is mounted with the flexible print cord 15 on the upper surface of the mounting substrate 14, fitting the ring 100 of the core 10b onto the step 130c of the bearing housing 13b.

In the event that the flexible print cord 15 is mounted on the upper surface of the mounting substrate 14, there are openings 140 in the mounting substrate 14 that correspond to the positions of the terminal pins 10c . . . , as shown in FIG. 1. Openings 140 on the mounting substrate 14 can accommodate the solder terminals of the terminal pins 10c . . . that protrude to the back surface of the flexible print cord 15, and an adhesive resin 141 can be packed into the openings 140 of the mounting substrate 14 to resin-mold the solder terminals of the terminal pins 10c . . .

In this way, the flexible print cord 15 is thin and there is no need for space to accommodate the solder terminals of the terminal pins 10c . . . , and so the mounting height of the stator 10 can be reduced.

Further, in the event that electronic components 16 such as Hall elements that detect rotation locations are mounted on the back surface of the flexible print cord 15, there can be openings 142 in the surface of the mounting substrate 14 that correspond to the mounting positions of the electronic components 16. The openings 142 in the mounting substrate 14 accommodate the electronic components mounted on the back surface of the circuit board 15; by packing the openings 142 in the mounting substrate 14 with an adhesive resin 143, it is possible to resin-mold the electronic components 16, and eliminate the mounting height of the the electronic components 16.

In assembling the rotor 11 and the hydraulic bearing 13, the lubricant (not illustrated) is packed into the cylinder of the bearing housing 13b, and the dynamic pressure sleeve 13d is fitted into the cylinder of the bearing housing 13b. As the dynamic pressure sleeve 13d is fitted in, the portions of the partition walls 131a to 131h that contact the inner cylinder of the hydraulic bearing 13b are formed as semicircular arcs, and so they can easily be pushed into the bearing housing 13b.

In the dynamic pressure sleeve 13d, the partition walls 131a to 131h and the cutout spaces 133a to 133h create a fluid sump 13f around the periphery of the dynamic pressure sleeve 13d, and so the lubricant can be reliably accommodated in equal portions within the cutout spaces 133a to 133h. Further, because a gap G is maintained so that there is a passage from the lower inward portions of the cutout spaces 133a to 133h to the thrust receiver 13a of the bearing housing 13b, there is a route for the lubricant to circulate from the thrust bearing 13a of the bearing housing 13b to the fluid receiver groove 13e of the bearing hole 13c.

The dynamic pressure sleeve 13d can be reliably held in place in the cylinder of the bearing housing 13b by a collar 17 pressing against the step 130c, as shown in FIG. 4. If the rotor shaft 11c, formed as a single piece with the hub 11d, is inserted into the bearing hole 13e of the dynamic pressure sleeve 13d, the rotor 11 is supported so that it can rotate within the hydraulic bearing 13, and can be assembled as an outer rotor, with the stator 10 accommodated inside the rotor 11.

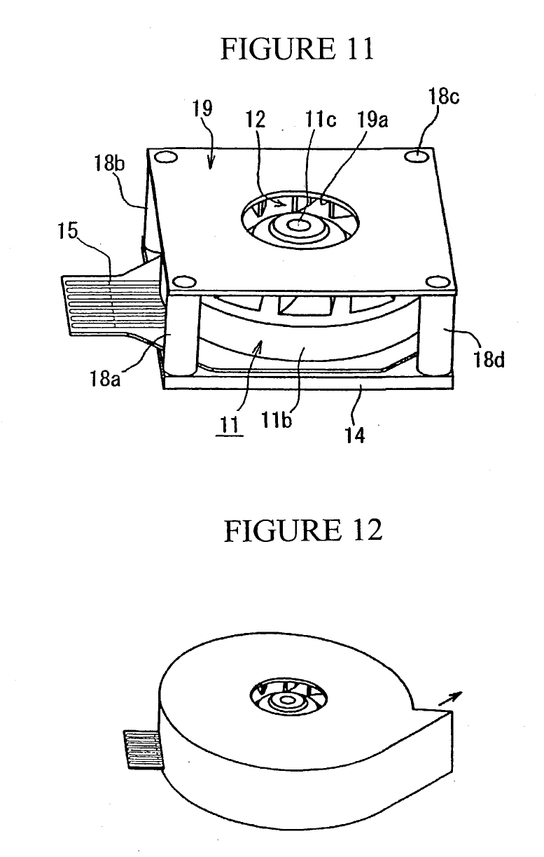

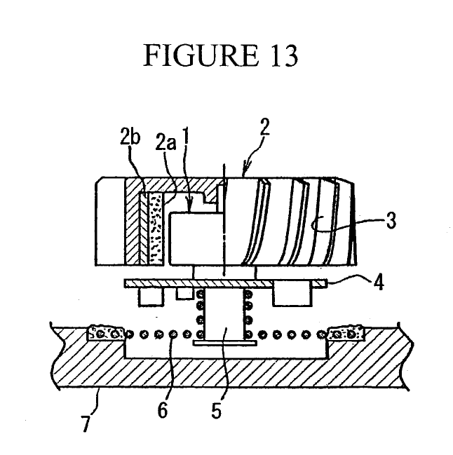

The stator 10 and the rotor 11 including the hydraulic bearing 13 are mounted on the mounting substrate 14, which has at its comers stays 18a to 18d, as shown in FIG. 10. By attaching a plate-shaped cover plate 19 with an air intake 19a as shown in FIG. 11, the fan motor is assembled with the cover plate 19 covering the impeller 12.

The fan motor constituted in this way suppresses the generation of noise because of the use of the hydraulic bearing 13, and provides longer service life because the simple provision for circulation of fluid allows smooth operation and a stable rate of rotation. Because the terminal pins 10c . . . are held erect by the resin outer frames 105a to 105d and a thin, flexible print cord is used as the circuit board 15, the motor can be made smaller and thinner overall.

In particular, the motor can be made smaller and thinner overall by accommodating the solder terminals of the terminal pins 10c . . . in the openings 140 in the mounting substrate 14, accommodating Hall elements and other electronic components 16 mounted on the back surface of the flexible print cord 15 in openings 142 in the mounting substrate and resin-molding the electronic components 16.

This fan motor is smaller, thinner and lighter; the generation of noise is suppressed, and service life is extended. It is therefore suitable for use in a forced-air feed type air cell, as shown in FIG. 12, to be mounted in mobile telephone, electronic notebook or other portable information equipment.

A forced-air feed type air cell is a primary cell that uses an activated carbon electrode as the anode and zinc as the cathode, and air as the anode activating substance; it is 30 to 40% lighter than a manganese dry cell. Because the fan motors mounted in air cells are small and thin with long service lives, they contribute to making the entire equipment smaller, thinner and lighter with a longer service life.

Beyond that, it is possible to constitute the fan motor described above as a fan motor with heat sink, by changing the shape of the cover plate 19 to that of a heat sink.

The mode of implementation described above was explained as a fan motor having an impeller 12, but it is similarly appropriate for assembling small, flat motors other than fan motors constituted with a stator 10, hydraulic bearing 13 and flexible print cord 15, or such motors mounted with electronic components 16.

The terms and expressions used in the specification of this invention are used simply for the purpose of explanation, and do not limit the content of the invention in any way. The use of any limiting terms or expressions is not intended to exclude thereby any equivalent mode of implementation or part thereof. It is clear, therefore, that it is possible to make various changes within the scope of the invention for which rights are claimed.

### POTENTIAL FOR INDUSTRIAL USE

If, as stated above, the hydraulic bearing of this invention is used in a small, flat motor, a number of partition walls that contact the inner surface of the bearing hole, separating cutout spaces that extend downward from the top surface that covers the openings between adjoining partition walls, form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces, by which means a lubricant can be reliably accommodated in equal portions within the cutout spaces and there is a reliable fluid route that enables the lubricant to circulate from the thrust receiver of the bearing housing to the fluid receiver groove of the bearing hole, thus constituting a hydraulic bearing that suppresses the generation of noise and also extends the service life.

Further, using the small, flat motor of this invention there is a stator with a coil wound on a core, and a rotor with a magnet that faces the core held by a yoke, the core having an insulating coating applied by a resin mold that covers both sides of the reel for winding the coil, and the stator being assembled with the coil wound on the reel of the core with the insulating material intervening between the coil and core. In this way, the coil can be reliably insulated, and the coil can be wound thinner, so that a thinner overall motor, including the stator, can be assembled.

Further, using the small, flat motor of this invention, an oxide coating is applied to the top and bottom surfaces of the core, which is formed from a silicon steel sheet. In this way, the coil can be reliably insulated, and the thickness of the coil winding can be reduced.

Further, using the small, flat motor of this invention, terminal pins hold the core at the outer framework of the insulating resin that has been applied, and a thin sheet of flexible print cord beneath the stator serves as a circuit board; one end of each terminal pin, to which the terminal of the coil is wired, is soldered and fixed to the flexible print cord. It is possible, therefore, to reliably wire the coil to the terminal pin, and to stably and reliably connect the circuit even when the flexible print cord is a thin plate.

Further, using the small, flat motor of this invention, there is a mounting substrate that has openings corresponding to the locations of the terminal pins; the openings in the mounting substrate accommodate terminal pin solder terminals that project to the back surface of the flexible print cord. By resin-molding these solder terminals with an adhesive resin packed in the openings, it is possible to eliminate the space needed to accommodate the terminal pin solder terminals, including cases where the flexible print cord is a thin plate, and so the mounting height of the stator can be reduced, and a thinner motor can be assembled.

Further, using the small, flat motor of this invention, there are a stator having a coil wound on a core, a rotor having a yoke that holds a magnet facing the core, a circuit board that makes a continuous circuit with the coil of the rotor and that has certain electronic components mounted on its back. There are openings in the mounting substrate corresponding to the positions where the electronic components are mounted, and these openings accommodate the electronic components mounted on the back of the circuit board. An adhesive resin is packed into the openings of the mounting substrate for resin molding of the electronic components, by which means the mounting height of the electronic components can be eliminated, and the motor as a whole can be made thinner.

Also, when the fan motor of this invention is used, there is a stator having a coil wound on a core, a rotor having a yoke that holds a magnet facing the core, and an impeller. There is a cylindrical bearing housing with a thrust receiver inside at the bottom, and a dynamic pressure sleeve that has a bearing hole that supports the rotor shaft of the motor and that is fitted and fixed within the bearing housing; a fluid receiver groove in the inner surface of the bearing hole accommodates fluid that flows around the rotor shaft from the thrust receiver of the bearing housing, and a number of partition walls that contact the inner surface of the bearing hole, separating cutout spaces that extend downward from the top surface that covers the openings between adjoining partition walls, form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces. By this means, a lubricant can be reliably accommodated in equal portions within the cutout spaces and there is a reliable fluid route that enables the lubricant to circulate from the thrust receiver of the bearing housing to the fluid receiver groove of the bearing hole, thus constituting a fan motor that suppresses the generation of noise and also extends the service life.

Moreover, by using the fan motor of this invention, which has a hydraulic bearing assembled from a bearing housing, which rises from the surface of the mounting substrate and is formed as a single piece with the mounting substrate, and a hydraulic sleeve that is fitted and fixed within the cylinder of the bearing housing, assembly of the hydraulic bearing is simplified.

By using the fan motor of this invention, which has a bearing housing formed in one piece with the mounting substrate of aluminum or a resin, it is possible to have a hydraulic bearing formed of light-weight aluminum or a shock-resistant resin.

Further, by using the forced-air feed type air cell of this invention which has a fan motor as described in any of claims 7 through 9 of this application, it is possible to constitute a forced-air feed type air cell that is smaller, thinner and lighter, and that suppresses the generation of noise and has longer service life.

Scope of claims:

1. A hydraulic bearing for a small, flat motor that has a cylindrical bearing housing with a thrust receiver inside at the bottom; a dynamic pressure sleeve that has a bearing hole that supports the rotor shaft of the motor and that is fitted and fixed within the bearing housing; and a fluid receiver groove in the inner surface of the bearing hole accommodates fluid that flows around the rotor shaft from the thrust receiver of the bearing housing,
in which a number of partition walls that contact the inner surface of the bearing hole, separating cutout spaces that extend downward from the top surface that covers the openings between adjoining partition walls, form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces.

2. A small, flat motor of this invention that has a stator with a coil wound on a core, and a rotor with a magnet that faces the core held by a yoke,
in which the core has an insulating coating applied by resin molding that covers both sides of the reel for winding the coil, and the stator is assembled with the coil wound on the reel of the core with the insulating material intervening between the coil and core.

3. A small, flat motor as described in claim 2 above, in which an oxide coating is applied to the top and bottom surfaces of the core, which is formed from a silicon steel sheet.

4. A small, flat motor as described in claim 2 or 3 above, in which terminal pins are held erect at the outer framework of the insulating resin that has been applied to the core, and a thin sheet of flexible print cord beneath the stator serves as a circuit board, one end of each terminal pin, to which the terminal of the coil is wired, being soldered and fixed to the flexible print cord.

5. A small, flat motor as described in claim 4 above, in which there is a mounting substrate that has openings corresponding to the locations of the terminal pins, there being openings in the mounting substrate that accommodate terminal pin solder terminals that project to the back surface of the flexible print cord.

6. A small, flat motor with a stator having a coil wound on a core, a rotor having a yoke that holds a magnet facing the core, and a circuit board that makes a continuous circuit with the coil of the rotor and that has certain electronic components mounted on its back,
in which there are openings in the mounting substrate corresponding to the positions where the electronic components are mounted, which openings accommodate the electronic components mounted on the back of the circuit board, and in which an adhesive resin is packed into the openings of the mounting substrate for resin molding of the electronic components.

7. A fan motor that has a stator having a coil wound on a core, a rotor having a yoke that holds a magnet facing the core, and an impeller,
in which there is a cylindrical bearing housing with a thrust receiver inside at the bottom, a dynamic pressure sleeve that has a bearing hole that supports the rotor shaft of the motor and that is fitted and fixed within the bearing housing, and a fluid receiver groove in the inner surface of the bearing hole accommodates fluid that flows around the rotor shaft from the thrust receiver of the bearing housing, with a number of partition walls that contact the inner surface of the bearing hole that separate cutout spaces that extend downward from the top surface that covers the openings between adjoining partition walls, and form a fluid sump around the outer surface of the dynamic pressure sleeve that is fitted inside the cylinder of the bearing housing, such that the dynamic pressure sleeve is fitted and fixed inside the cylinder of the bearing housing with a gap maintained between the thrust receiver of the bearing housing and the lower and inward portions of the cutout spaces.

8. A fan motor as described in claim 7 above, in which there is a hydraulic bearing assembled from a bearing housing, which rises from the surface of the mounting substrate and is formed as a single piece with the mounting substrate, and a hydraulic sleeve that is fitted and fixed within the cylinder of the bearing housing.

9. A fan motor as described in claim 8 above, in which there is a bearing housing formed in one piece with the mounting substrate of aluminum or a resin.

10. A forced-air feed type air cell, in which there is a fan motor as described in any of claims 7 through 9 of this application.
